(19) United States
(12) Patent Application Publication
(10) Pub. No.: US 2025/0029004 A1
(43) Pub. Date: Jan. 23, 2025

(54) METHOD AND APPARATUS FOR SUPPORTING MACHINE LEARNING MODEL UPDATE IN TERMINAL OR BASE STATION IN MOBILE COMMUNICATION SYSTEM

(71) Applicant: Electronics and Telecommunications Research Institute, Daejeon (KR)

(72) Inventors: Chang Sik LEE, Daejeon (KR); Tae Yeon KIM, Daejeon (KR); Taeheum NA, Daejeon (KR); Seungjae SHIN, Daejeon (KR)

(21) Appl. No.: 18/651,555

(22) Filed: Apr. 30, 2024

(30) Foreign Application Priority Data
Jul. 17, 2023 (KR) 10-2023-0092574
Nov. 2, 2023 (KR) 10-2023-0149927
Mar. 6, 2024 (KR) 10-2024-0031804

(51) Int. Cl. G06N 20/00

(52) U.S. Cl. CPC G06N 20/00

(57) ABSTRACT

Proposed is a technology that supports updating a machine learning model in a terminal or base station of a mobile communication system. The method where a core network supports a machine learning (ML) model update may include receiving by a first network function in the core network a model update request from a user equipment (UE) or a radio access network (RAN), obtaining by the first network function information for the model update on the basis of the received model update request and a communication with a second network function, and transferring by the first network function to the UE or the RAN a model update response including the information for the model update.

### CROSS REFERENCE TO RELATED APPLICATION

The present application claims priority to Korean Patent Application No. 10-2023-0092574, filed on Jul. 17, 2023, No. 10-2023-0149927, filed on Nov. 2, 2023, No. 10-2024-0031804, filed on Mar. 6, 2024, the entire contents of which are incorporated herein for all purposes by this reference.

### BACKGROUND

### Technical Field

The present disclosure relates to automation technology in mobile communication systems and, more specifically, to a technology that supports updating a machine learning model in a terminal or base station of a mobile communication system in some exemplary embodiments.

### Description of the Related Art

Recently, a radio access network (RAN) and a 5G core (5GC) have structurally evolved in mobile communication systems in order to provide new types of services by combining communication technologies and artificial intelligence technologies.

The 5GC provides functions such as a collection of mobile data, storage, learning, reasoning, and the like through a network data analysis function (NWDAF) and an analysis data repository function (ADRF).

In addition, The RAN utilizes a variety of machine learning (ML) models for beam management, positioning, and channel state information (CSI) feedback enhancement to provide optimal control over radio sections.

However, when utilizing such ML models, the performance of the model may degrade depending on changes in time or changes in the surrounding environment, so a technology to update a user equipment (hereinafter referred to as UE) or an ML model running on the RAN with a new ML model is necessary to solve the problem. For example, a technology to receive a new machine learning model from the 5GC is necessary when the performance of the ML model running in the UE or the RAN area drops below a threshold.

### SUMMARY

Therefore, the present disclosure is to provide a technology (e.g., support methods and procedures) to update machine learning models in the UE or the RAN areas and transfer new models in 5G mobile communication systems.

In a method where a core network supports a machine learning (ML) model update, an aspect of the present disclosure may provide a method that includes receiving by a first network function in the core network from a user equipment (UE) or a radio access network (RAN) a model update request which includes a model identifier of an ML model, obtaining by the first network function information for the model update on the basis of the received model update request and a communication with a second network function, and transferring by the first network function to the UE or the RAN a model update response including the information for the model update.

In some exemplary embodiments, the model update request may include the model identifier and a recommendation indicator, and the model update request may request the first network function to provide the ML models recommended on the basis of the model identifier when the recommendation indicator has a value of ‘true’.

In some exemplary embodiments, the model update response may include at least one tuple and each of the at least one tuple may include the model identifier of the corresponding ML model and a file of the ML model corresponding to the model identifier or an address in which the file is stored.

In some exemplary embodiments, the second network function may include an ADRF, and the obtaining the information for the model update may include transferring by the first network function a model management retrieve request to the ADRF and receiving from the ADRF a model management retrieve response that is the basis for obtaining the information for the model update.

In some exemplary embodiments, the model management retrieve request may essentially include at least one of an analytics identifier correlated with the model identifier and the model identifier while optionally including a recommendation indicator, and the model management retrieve request may request the ADRF to provide the ML model recommended on the basis of the model identifier when the recommendation indicator has a value of ‘true’.

In some exemplary embodiments, the model management retrieve request may be a request based on a Nadrf_MLModelManagement_RetrievalRequest service operation.

In some exemplary embodiments, the model management retrieve response may include at least one tuple and each of the at least one tuple may include the model identifier of the corresponding ML model and an address in which a file of the ML model corresponding to the model identifier is stored.

In some exemplary embodiments, the method may further include obtaining by the first network function a file of at least one ML model on the basis of the model management retrieve response and the model update information may include the obtained file.

In some exemplary embodiments, the second network function may include an NWDAF and the obtaining the information for the model update may further include transmitting by the first network function a model provision request to the NWDAF and receiving a model provision response that is the basis for obtaining the information for the model update.

In some exemplary embodiments, the model provision request may essentially include at least one of an analytics identifier correlated with the model identifier and the model identifier while optionally including a recommendation indicator, and the model provision request may request the NWDAF to provide the ML model recommended on the basis of the model identifier when the recommendation indicator has a value of ‘true’.

In some exemplary embodiments, the model provision request may be a request based on an Nnwdaf_MLModelProvision_Subscribe service operation.

In some exemplary embodiments, the model provision request may be a request based on an Nnwdaf_MLModelInfo_Request service operation.

In some exemplary embodiments, the method may further include transmitting by the NWDAF a model management retrieve request to the ADRF on the basis of the model provision request and receiving from the ADRF a model management retrieve response that is the basis for generating the model provision response.

In some exemplary embodiments, the model management retrieve request may essentially include at least one of an analytics identifier correlated with the model identifier and the model identifier while optionally including a recommendation indicator, and the model management retrieve request may request the ADRF to provide an ML model recommended on the basis of the analytics identifier or the model identifier when the recommendation indicator has a value of ‘true’.

In some exemplary embodiments, the ADRF may generate the model management retrieve response by querying all ML models correlated with the analytics identifier when the model management retrieve request includes the analytics identifier.

In some exemplary embodiments, the model management retrieve response may include at least one tuple and each of the at least one tuple may include the model identifier of the corresponding ML model and an address where a file of the ML model corresponding to the model identifier is stored.

In some exemplary embodiments, the first network function may include an AMF.

In a method where a UE performs an ML model update, another aspect of the present disclosure may provide a method which includes transmitting to the first network function of the core network a model update request which includes a model identifier of an ML model when the model updates correlated with the ML model in operation is determined to be necessary, receiving from the first network function the model update response that includes information for the model update, and performing the ML model update on the basis of the information for the model updates.

In some exemplary embodiments, the determining step may include determining that the model update is necessary when the performance of the ML model in operation is evaluated and the performance of the ML model does not satisfy a predetermined criterion.

In some exemplary embodiments, the model update request may include the model identifier and a recommendation indicator, and the model update request may request the first network function to provide the ML model recommended on the basis of the model identifier when the recommendation indicator has a value of ‘true’.

Another aspect of the present disclosure as a communication device may provide a communication apparatus that includes a processor, one or more hardware-based transceivers, and a computer-readable storage medium including instructions, wherein the instructions respond to the execution by the processor and enable the communication apparatus to perform at least one of exemplary embodiments of the method of the present disclosure.

In a non-transitory recording medium that stores instructions readable by a processor of an electronic apparatus, another aspect of the present disclosure may provide a recording medium where the instructions enable the processor to perform exemplary embodiments of the present disclosure.

This outline is provided to introduce in a simplified form a selection of the concepts that are further explained in the detailed description below. The present outline is not intended to identify key features or essential features of the subject matter of the claimed disclosure, nor is it intended to be used to limit the scope of the subject matter of the claimed disclosure. In addition, the subject matter of the claimed disclosure is not limited to implementations that solve some or all of the problems mentioned in any part of the present specification. In addition to the exemplary aspects, exemplary embodiments and features described above, additional aspects, exemplary embodiments, and features will be clarified with reference to the detailed description and drawings below.

Some exemplary embodiments of the present disclosure may have effects including the following advantages. However, it does not mean that all exemplary embodiments should include all of them, and the scope of the present disclosure should not be understood as being limited thereto.

According to some exemplary embodiments, it may be possible to manage a machine learning model across UE/RAN/core network domains and provide high-quality services by updating the machine learning model running in the terminal or the RAN area of the 5G mobile communication system with a new model as needed.

### BRIEF DESCRIPTION OF THE DRAWINGS

FIG. 1 is a view showing a reference architecture for describing an ML model update/transmission scenario through the 5GC.

FIG. 2 is a view describing some exemplary embodiments for a procedure in which the 5GC supports an ML model update/transmission.

FIG. 3 is a view showing a service description for explaining some exemplary embodiments of a model update request and a model update response.

FIG. 4 is a view showing a service description for explaining some exemplary embodiments of a model management retrieve request and a model management retrieve response.

FIGS. 5 and 6 are respectively a view showing a service description for explaining some exemplary embodiments of a model provision request and a model provision response.

FIG. 7 is a view showing a block diagram for explaining an internal configuration of an electronic apparatus (e.g., a UE, a RAN, or a module located in a core network) according to an exemplary embodiment of the present disclosure.

### DETAILED DESCRIPTION OF THE DISCLOSURE

Since the description of the present disclosure is only an exemplary embodiment for structural or functional description, the scope of the present disclosure should not be construed as being limited by the exemplary embodiments described herein. That is, as the exemplary embodiment may be modified in various ways and may have various forms, the scope of the present disclosure should be understood as including equivalents that can realize the technical idea. In addition, since the purpose or effect presented in the present disclosure does not mean that a specific exemplary embodiment should include all or only such effects, the scope of the present disclosure should not be understood as being limited thereto.

Meanwhile, the meaning of terms described in the present disclosure should be understood as follows.

Terms such as “a first” and “a second” are intended to distinguish one component from another, and the scope of rights should not be limited by these terms. For example, a first component may be referred to as a second component, and similarly a second component may be referred to as a first component.

When it is mentioned that a component is “connected” to another component, it should be understood that it may be directly connected to the other component, but that another component may exist in between. On the other hand, when it is mentioned that one component is “directly connected” to another component, it should be understood that no other component exists in between. Meanwhile, other expressions that describe the relationship between components, such as “between” and “immediately between” or “neighboring to” and “directly neighboring to”, should be interpreted similarly.

Singular expressions should be understood as containing multiple expressions unless the context clearly indicates otherwise, and terms such as “include” or “have” should be understood to specify the presence of an implemented feature, number, step, action, component, part, or combination thereof, and are not intended to preclude the possibility of the presence or addition of one or more other features, numbers, steps, actions, components, parts, or combinations thereof.

In each step, the identification code (e.g., a, b, c, etc.) is used for the convenience of explanation, and the identification code does not describe the order of each step, and each step may occur differently from the specified order unless a specific order is clearly described in the context. That is, each step may occur in the same manner as the specified order, may be performed substantially simultaneously, or may be performed in the opposite order.

Some exemplary embodiments of the present disclosure may include a technology in which a 5GC supports an ML model update and transfers to the UE or RAN.

Both a RAN and the 5GC have been utilizing an artificial intelligence (AI)/ML technology to improve the wireless interface and the 5GC intelligence. Such an evolution toward an AI-based network architecture may help operators to efficiently control a network architecture and to provide a high-quality network service.

However, as the network environment changes, the performance of the ML model may degrade over time. In order to solve the problem, research has been conducted on how to monitor the performance of ML models in the 5GC field, and several solutions have been proposed. Examples of these solutions may include analysis feedback from consumer network functions (NFs), performance degradation checks for an MLTF-based ML model, and model accuracy checks for AnLF-supported models.

However, no technology has yet been proposed to manage ML models in the UE and the RAN parts in the above study.

Thus, some exemplary embodiments of the present disclosure may include techniques to manage ML models of the UE and the RAN parts in the 5GC for stable network services.

In some exemplary embodiments, when receiving an ML model update request from the UE and the RAN, the 5GC may update and transfer the corresponding ML model to the UE and the RAN.

In some other exemplary embodiments, the 5GC may update and transfer the corresponding ML model to the UE and the RAN not only when the UE or the RAN requests the ML model update, but also in other cases such as when the 5GC updates and transfers the ML model after monitoring the performance of the ML model of the UE or the RAN.

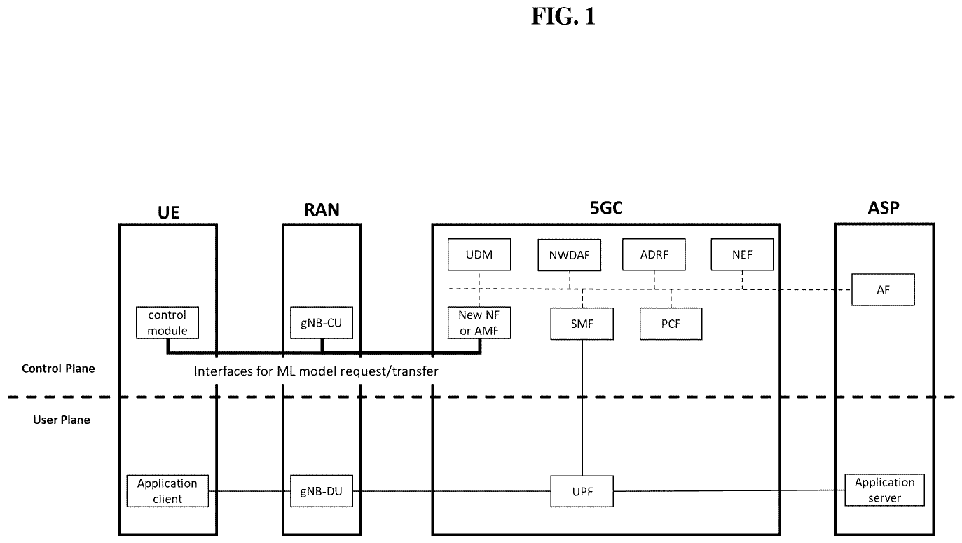

FIG. 1 is a view showing a reference architecture for describing an ML model update/transmission scenario through the 5GC.

As shown in FIG. 1, the reference architecture may include a UE, a RAN, a 5GC, and an application service provider (ASP).

The AI/ML service traffic may be exchanged between an application client of the UE and an application server of the ASP. This AI/ML traffic may be exchanged through a gNB-DU (a distributed device) of the RAN and a user plane (hereinafter, referred to as a UP) function (hereinafter, referred to as a UPF) of the 5GC.

Such a UP operation may be directly influenced by the control technique of a control plane (CP). In the case of a federated learning (FL), the UE's application client may transmit the weight parameters of the ML model to the application server through the UP after the control module of the UE performs a local training of the ML model.

In addition, the RAN's gNB-CU (a central device) may control gNB-DUs (a distributed device) on the basis of the ML model for optimal operations (e.g., beam management, positioning, CSI feedback improvement). The UE or the RAN may hold the ML model in its own repository or receive the ML model from the 5GC or the ASP.

In this context, some exemplary embodiments of the present disclosure may include a method in which the 5GC supports updating and transferring ML models with respect to the UE and the RAN.

In some exemplary embodiments, the UE may determine whether to update the ML model. For example, the UE may request an ML model update when the performance of the ML model is less than or equal to a threshold.

In some other exemplary embodiments, the RAN may determine whether to update the ML model. For example, the RAN may request the ML model update when the performance of the ML model is less than or equal to a threshold.

In some other exemplary embodiments, the 5GC may determine whether to update the ML model. For example, the 5GC may perform a procedure of the ML model update when the performance of the ML model is determined to be insufficient while monitoring the performance of the ML model running in the UE or the RAN.

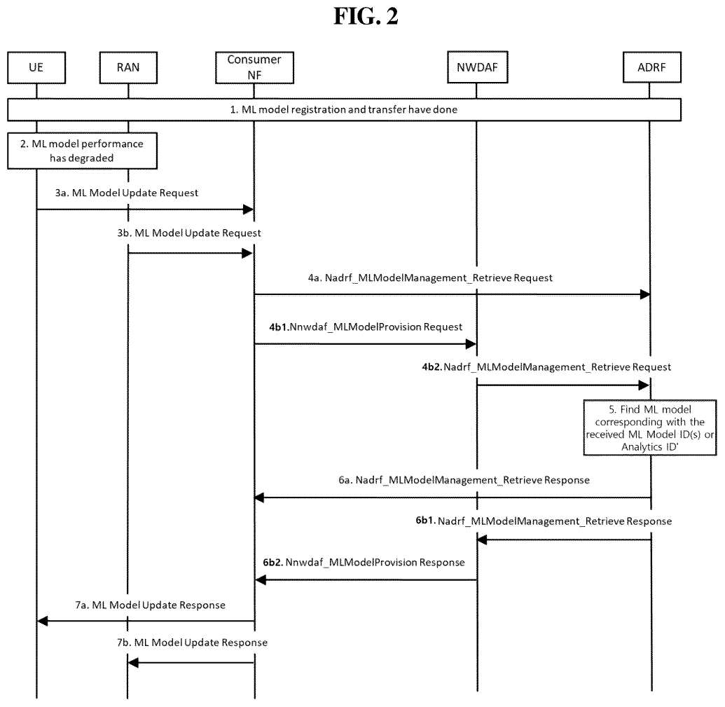

FIG. 2 is a view explaining some exemplary embodiments with respect to a procedure in which the 5GC supports an ML model update/transmission.

FIG. 2 may be a view including a procedure of an ML model update/transmission with respect to the UE or the RAN.

As shown in FIG. 2, the first network function (Consumer NF), NWDAF, and ADRF included in the UE, the RAN, and the 5GC are shown.

In some exemplary embodiments as shown in FIG. 2, the ML model set trained in the step 1 may already be registered to the 5GC (that is, NWDAF or ADRF) and transferred to the UE or the RAN. The corresponding ML model transferred in this way may be executed by the UE or the RAN.

In some exemplary embodiments as shown in FIG. 2, the UE or the RAN may determine whether to update ML models. As an example, the UE or the RAN may continuously check the accuracy of the ML model and determine whether to update the ML model (e.g., the model update is determined to be necessary when the performance of the ML model does not satisfy a predetermined criterion after evaluating the performance of the ML model in operation). As another example, the UE or the RAN may determine whether to update the ML model by receiving information on the accuracy of the ML model from the 5GC which monitors the performance of the ML model on behalf of the UE and the RAN.

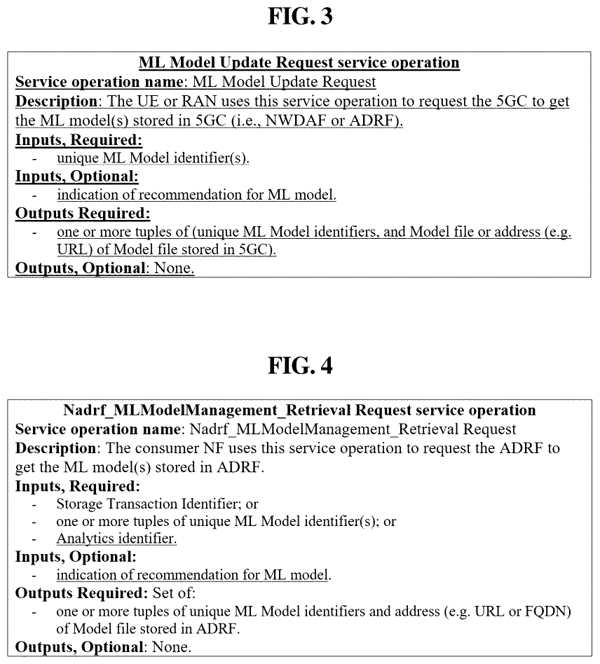

FIG. 3 is a view showing a service description for explaining some exemplary embodiments of a model update request and a model update response. For example, the service description of FIG. 3 may be additionally included in the standard document (e.g., 3GPP TS 23.288) as a service description newly presented by the present disclosure.

In some exemplary embodiments, the UE or the RAN may transmit a model update request to the first network function of the core network when determining that the model update correlated with the ML model in operation is necessary. For example, as shown in 3a of FIG. 2 the UE may transmit a model update request to the first network function when determining that the model update correlated with the ML model in operation is necessary. As another example as shown in 3b of FIG. 2, the RAN may transmit the model update request to the first network function when determining that the model update correlated with the ML model in operation is necessary.

In some exemplary embodiments, the first network function may be a Consumer NF, for example, it may be an AMF, or in another example, it may be a new network function for the corresponding service rather than the AMF.

In some exemplary embodiments as shown in FIG. 3, the model update request may essentially include the model identifier of the ML model while optionally including a recommendation indicator. In some exemplary embodiments, the model update request may request the first network function to provide an ML model recommended on the basis of the model identifier when the recommendation indicator included in the model update request has a value of ‘true’.

In some exemplary embodiments, the first network function may obtain information for model updates on the basis of the received model update request and a communication with a second network function. For example, the first network function may obtain the information for model updates on the basis of a communication with the ADRF corresponding to 4a and 6b exemplified in FIG. 2. As another example, the first network function may obtain the information for model updates on the basis of a communication with the NWDAF corresponding to 4b1 and 6b2 exemplified in FIG. 2.

In some exemplary embodiments as shown in 7a and 7b of FIG. 2, the first network function may transfer to the UE or the RAN a model update response including the information for model updates.

In some exemplary embodiments as shown in FIG. 3, the model update response may include at least one tuple and each of the at least one tuple may include a model identifier of the corresponding ML model and a file of the ML model corresponding to the model identifier or an address in which the file is stored.

In some exemplary embodiments, the UE or the RAN may perform ML model updates on the basis of the information received for model updates.

Referring to FIG. 2, the UE may transfer the model update request (ML Model Update Request of FIG. 2) to the first network function in the step 3a. For example, the transmission of the ML model update request may be performed in the step 3a when the UE determines that the accuracy of the ML model is not sufficient in the step 2. In some exemplary embodiments, the ML model update request may essentially include the model identifier (Model ID) and optionally include an ML model recommendation indicator. For example, when the ML model recommendation indicator has a value of ‘true’, the model update request may indicate a request to the 5GC to recommend a model that is used for the same inference (e.g., Analytics).

Referring to FIG. 2, the RAN may transfer the model update request (ML model update request of FIG. 2) to the first network function in the step 3b. For example, the transmission of the ML model update request may be performed in the step 3b when the RAN determines that the accuracy of the ML model is not sufficient in the step 2. In this case, the items that may be included in the ML model update request are as described above.

In some exemplary embodiments, the model update request may correspond to an input with respect to a service operation of FIG. 3, and the model update response may correspond to an output with respect to the service operation of FIG. 3.

FIG. 4 is a view exemplifying a service description for explaining some exemplary embodiments of a model management retrieve request and a model management retrieve response.

For example, the exemplary embodiment of the service description in FIG. 4 may be an improvement in the service description disclosed in the standard document (e.g., 3GPP TS 23.288), and may further include an analytics identifier and a recommendation indicator compared to the service description of the existing standard document.

In some exemplary embodiments as shown in FIG. 2, the first network function that received the corresponding request may transmit a model management retrieve request to the second network function (in this case, the ADRF) (step 4a), and receive from the second network function a model management retrieve response which is the basis for obtaining the information for model updates (step 6a).

In some exemplary embodiments, the model management retrieve request in the step 4a may essentially include at least one of an analytics identifier correlated with the model identifier and the model identifier while optionally including a recommendation indicator. In some exemplary embodiments, the model management retrieve request may indicate a request to ADRF to provide an ML model recommended on the basis of the model identifier when the recommendation indicator has a value of ‘true’. In some exemplary embodiments, the model management retrieve request may be performed by calling the Nadrf_MLModelManagement_RetrievalRequest service operation as shown in FIG. 4.

The step 5 in FIG. 2 will be described later.

In some exemplary embodiments, the model management retrieve response in the step 6a may include at least one tuple and each of the at least one tuple may include a model identifier of the corresponding ML model and an address in which a file of the ML model corresponding to the model identifier is stored.

In some exemplary embodiments, the first network function may enable at least one tuple included in the model management retrieve response to be included in the information for model updates and provide to the UE or the RAN. In some other exemplary embodiments, the first network function may obtain (e.g., download) a file of at least one ML model on the basis of the model management retrieve response, and provide to the UE or the RAN after having the obtained file be included in the information for model updates.

In some exemplary embodiments, the model management retrieve request may correspond to an input with respect to a service operation of FIG. 4, and the model management retrieve response may correspond to an output with respect to a service operation of FIG. 4.

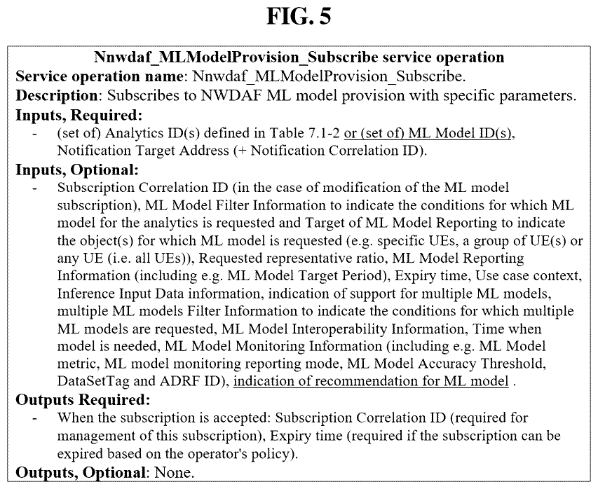

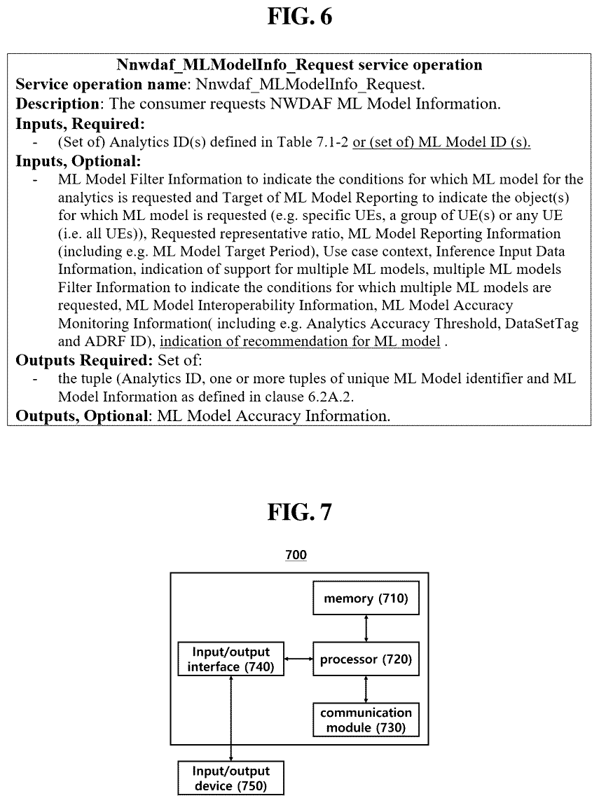

FIGS. 5 and 6 are respectively a view exemplifying a service description for explaining some exemplary embodiments of a model provision request and a model provision response.

For example, the exemplary embodiments of the service descriptions of FIGS. 5 and 6 may be an improvement in the service description disclosed in the standard document (e.g., 3GPP TS 23.288), and may further include a model identifier and a recommendation indicator compared to the service description of the existing standard document.

In some other exemplary embodiments as shown in FIG. 2, the first network function that receives the corresponding request may transmit a model provision request to the second network function (in this case, the NWDAF) (step 4b1), and receive from the second network function a model provision response that is the basis for obtaining the information for model updates (the step 6b2).

In some exemplary embodiments, the model provision request in the step 4b1 may essentially include at least one of an analytics identifier correlated with the model identifier and the model identifier and optionally include a recommendation indicator. In some exemplary embodiments, the model provision request in the step 4b1 may be a message that requests to provide an ML model recommended on the basis of the model identifier when the recommendation indicator has a value of ‘true’. In some exemplary embodiments, the model provision request in the step 4b1 may be performed by calling the Nnwdaf_MLModelProvision_Subscribe service operation as shown in FIG. 5. In some other exemplary embodiments, the model provision request may be performed by calling the Nnwdaf_MLModelInfo_Request service operation as shown in FIG. 6.

In some exemplary embodiments as shown in FIG. 2, the first network function that receives the model provision request in the step 4b1 may transmit a model management retrieve request to the ADRF (the step 4b2) and receive a model management retrieve response from the ADRF that is the basis for generating the model provision response (the step 6b1).

In some exemplary embodiments, the model management retrieve request in the step 4b2 may include at least one of both an analytics identifier correlated with the model identifier and the model identifier and a recommendation indicator. In some exemplary embodiments, the model management retrieve request may be a message that requests the ADRF to provide the ML model recommended on the basis of the analytics identifier or the model identifier when the recommendation indicator included in the model management retrieve request has a value of ‘true’. In some exemplary embodiments, the model management retrieve request may be performed by calling the Nadrf_MLModelManagement_RetrievalRequest service operation. In some exemplary embodiments, the NWDAF may find the analytics identifier to which the received model identifier belongs and may then determine a set of model identifiers that belong to the corresponding analytics identifier.

In some exemplary embodiments, the model management retrieve response in the step 6b1 may include at least one tuple and each of the at least one tuple may include the model identifier of the corresponding ML model and an address in which a file of the ML model corresponding to the model identifier is stored.

In some exemplary embodiments as shown in FIG. 2, the ADRF may retrieve and determine a model to be recommended on the basis of the information included in the model management retrieve request which is received in the step 4a or the step 4b2 (the step 5), and may transmit a model management retrieve response (the step 6a or 6b1). For example, the ADRF may retrieve and determine a model to be recommended on the basis of the model identifier. In another example, the ADRF may retrieve and determine all ML models correlated with the analytics identifier when the received model management retrieve request does not include the model identifier but includes the analytics identifier. As another example, the ADRF may find the analytics identifier to which the received model identifier belongs and may retrieve and determine all ML models correlated with the corresponding analytics identifier when the received model management retrieve request includes the model identifier and the recommendation indicator has a value of ‘true’.

In some exemplary embodiments as shown in FIG. 2, the NWDAF may provide the model provision response to the first network function in the step 6b2. In some exemplary embodiments, the model provision response may include at least one tuple and each of the at least one tuple may include the model identifier of the corresponding ML model and an address in which a file of the ML model corresponding to the model identifier is stored.

FIG. 7 is a view showing a block diagram for explaining an internal configuration of an electronic apparatus (e.g., a UE, a RAN, or a module located in a core network) according to an exemplary embodiment of the present disclosure.

As shown in FIG. 7, the electronic apparatus 700 may include a memory 710, a processor 720, a communication module 730, and an input/output interface 740. The memory 710 is a computer-readable recording medium and may include a random access memory (RAM), a read only memory (ROM), and a permanent mass storage device such as a disk drive. Herein, the ROM and the permanent mass storage device may be separated from the memory 710 and may be included as a separate permanent storage device. Also, the memory 710 may store an operating system and at least one program code (e.g., a computer program stored on a recording medium that the electronic apparatus 700 includes in order to control the electronic apparatus 700 to perform methods according to exemplary embodiments of the present disclosure). The software components may be loaded from a computer-readable recording medium which is separate from the memory 710. Such a separate computer-readable recording medium may include a recording medium readable by a computer such as a floppy disk drive, a disk, a tape, a DVD/CD-ROM drive, a memory card or the like. In other exemplary embodiments, software components may be loaded into the memory 710 via the communication module 730 rather than a computer-readable recording medium.

The processor 720 may be configured to process instructions of a computer program by performing basic arithmetic, logic, and input/output operations. The instructions may be provided to the processor 720 by the memory 710 or the communication module 730. For example, the processor 720 may be configured to execute an instruction that is received according to a program code loaded in the memory 710. As a more specific example, the processor 720 may sequentially execute instructions in accordance with a code of a computer program loaded in the memory 710 in order to perform the method according to exemplary embodiments of the present disclosure. The communication module 730 may provide a function for communicating with other physical devices through an actual computer network. For example, the processor 720 of the electronic apparatus 700 may perform part of the process of the present exemplary embodiment, and another physical device (e.g., another computing system not shown) of the network may perform the remaining processes, so that an exemplary embodiment of the present disclosure is performed in a way that the processing result is exchanged through the computer network and the communication module 730.

The input/output interface 740 may be a means for interfacing with the input/output device 750. For example, in the input/output device 750, the input device may include a device such as a keyboard or a mouse, and the output device may include a device such as a display or a speaker. Although the input/output device 750 is expressed as a device separate from the electronic apparatus 700 in FIG. 7, the electronic apparatus 700 may be implemented such that the electronic apparatus 700 includes the input/output device 750 according to an exemplary embodiment.

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

What is claimed is:

1. A method where a core network supports a machine learning (ML) model update, the method comprising:
receiving by a first network function in the core network from a user equipment (UE) or a radio access network (RAN) a model update request that comprises a model identifier of an ML model;
obtaining by the first network function information for the model update on the basis of the received model update request and a communication with a second network function; and
transferring by the first network function to the UE or the RAN a model update response that comprises the information for the model update.

2. The method of claim 1, wherein the model update request comprises the model identifier and a recommendation indicator, and
the model update request requests the first network function to provide the ML model recommended on the basis of the model identifier when the recommendation indicator has a value of ‘true’.

3. The method of claim 1, wherein the model update response comprises at least one tuple, and
each of the at least one tuple comprises the model identifier of the corresponding ML model and a file of the ML model corresponding to the model identifier or an address in which the file is stored.

4. The method of claim 1, wherein the second network function comprises an ADRF, and
the obtaining the information for the model update comprises of the first network function transmitting a model management retrieve request to the ADRF and receiving from the ADRF a model management retrieve response that is the basis for obtaining the information for the model update.

5. The method of claim 4, wherein the model management retrieve request essentially comprises at least one of an analytics identifier correlated with the model identifier and the model identifier, while optionally comprising a recommendation indicator, and
the model management retrieve request requests the ADRF to provide the ML model recommended on the basis of the model identifier when the recommendation indicator has a value of ‘true’.

6. The method of claim 4, wherein the model management retrieve request is a request based on a Nadrf_MLModelManagement_RetrievalRequest service operation.

7. The method of claim 4, wherein the model management retrieve response comprises at least one tuple, and
each of the at least one tuple comprises the model identifier of the corresponding ML model and an address in which a file of the ML model corresponding to the model identifier is stored.

8. The method of claim 4, further comprising of the first network function obtaining a file of at least one ML model on the basis of the model management retrieve response, wherein the model update information comprises the obtained file.

9. The method of claim 1, wherein the second network function comprises an NWDAF, and
the obtaining the information for the model update comprises of the first network function transmitting a model provision request to the NWDAF and receiving from the NWDAF a model provision response that is the basis for obtaining the information for the model update.

10. The method of claim 9, wherein the model provision request essentially comprises at least one of an analytics identifier correlated with the model identifier and the model identifier while optionally comprising a recommendation indicator, and
the model provision request requests the NWDAF to provide the ML model recommended on the basis of the model identifier when the recommendation indicator has a value of ‘true’.

11. The method of claim 9, wherein the model provision request is a request based on an Nnwdaf_MLModelProvision_Subscribe service operation.

12. The method of claim 9, wherein the model provision request is a request based on an Nnwdaf_MLModelInfo_Request service operation.

13. The method of claim 9, further comprising of the NWDAF transmitting a model management retrieve request to the ADRF on the basis of the model provision request and receiving from the ADRF a model management retrieve response that is the basis for generating the model provision response.

14. The method of claim 13, wherein the model management retrieve request essentially comprises at least one of an analytics identifier correlated with the model identifier and the model identifier, while optionally comprising a recommendation indicator, and
the model management retrieve request requests the ADRF to provide the ML model recommended on the basis of the analytics identifier or the model identifier when the recommendation indicator has a value of ‘true’.

15. The method of claim 13, wherein the ADRF generates the model management retrieve response by querying all ML models correlated with the analytics identifier when the model management retrieve request comprises the analytics identifier.

16. The method of claim 13, wherein the model management retrieve response comprises at least one tuple, and
each of the at least one tuple comprises the model identifier of the corresponding ML model and an address where a file of the ML model corresponding to the model identifier is stored.

17. The method of claim 1, wherein the first network function comprises an AMF.

18. A method where a UE performs an ML model update, the method comprising:
transmitting to a first network function of a core network a model update request which comprises a model identifier of an ML model when the model update correlated with the ML model in operation is determined to be necessary,
receiving from the first network function a model update response which comprises information for the model update, and
performing the ML model update on the basis of the information for the model update.

19. The method of claim 18, wherein the determining step comprises determining that the model update is necessary when a performance of the ML model in operation is evaluated and the performance of the ML model does not satisfy a predetermined criterion.

20. The method of claim 18, wherein the model update request comprises the model identifier and a recommendation indicator, and
the model update request requests the first network function to provide the ML model recommended on the basis of the model identifier when the recommendation indicator has a value of ‘true’.
